(19) United States
(12) Patent Application Publication
(10) Pub. No.: US 2013/0231861 A1
(43) Pub. Date: Sep. 5, 2013

(54) TERMINAL DEVICE, IMAGE DISPLAYING METHOD AND IMAGE DISPLAYING PROGRAM EXECUTED BY TERMINAL DEVICE

(71) Applicants: Ryu Yokoyama, Ota-ku (JP); Hideaki Takahashi, Ageo (JP); Satoru Ito, Saitama-shi (JP); Masaya Hashida, Itabashi (JP)

(72) Inventors: Ryu Yokoyama, Ota-ku (JP); Hideaki Takahashi, Ageo (JP); Satoru Ito, Saitama-shi (JP); Masaya Hashida, Itabashi (JP)

(73) Assignee: PIONEER CORPORATION, KANAGAWA (JP)

(21) Appl. No.: 13/988,023

(22) PCT Filed: Nov. 18, 2010
(86) PCT No.: PCT/JP2010/070589

§ 371 Date: May 23, 2013

(51) Int. Cl. G01C 21/20

(52) U.S. Cl. CPC G01C 21/20
USPC 701/523

(57) ABSTRACT

A terminal device mounted on a movable body, includes: an image capturing unit; a determining unit which determines whether to preferentially display an actually captured guide image using a captured image captured by the image capturing unit or a map guide image using map information, based on a relationship between an image capturing direction of the image capturing unit and a traveling direction of the movable body; and a display controlling unit which displays either the actually captured guide image or the map guide image based on a determination by the determining unit. Therefore, it is possible to appropriately determine whether to preferentially display the actually captured guide image or the map guide image.

### TECHNICAL FIELD

The present invention relates to a terminal device having a function of a route guide.

### BACKGROUND TECHNIQUE

This kind of technique is proposed in Patent References 1 and 2, for example. In Patent Reference-1, as for a portable terminal device with a navigation function, there is proposed a technique for selectively starting the navigation function when the portable terminal device is attached to a handsfree device equipped in a vehicle. In Patent Reference-2, there is proposed a technique for automatically switching between a map image using map information and an actually captured image showing an outside of the vehicle, in accordance with an outside condition of the vehicle. The outside condition of the vehicle is a shielding degree by a front obstacle (for example, vehicle), an outside brightness, a rain, a fog, a distance of a front vehicle, an attribute of a road and a presence or absence of a landmark (for example, a traffic signal or a convenience store).

### PRIOR ART REFERENCE

### Patent Reference

Patent Reference-1: Japanese Patent Application Laid-open under No. 2007-163386
Patent Reference-2: International Patent Application Laid-open under No. 2007-129382

### SUMMARY OF INVENTION

### Problem to be Solved by the Invention

Conventionally, there is proposed a technique for installing a portable type terminal device such as a high-function portable telephone called “smartphone” in a vehicle by a holding device called “cradle”. Additionally, there is proposed a navigation called “AR navigation (AR: Augmented Reality)” which uses an actually captured image by a camera of the smartphone. The AR navigation displays an image for a route guide, such as a direction and a distance to a destination, in a manner superimposed on the actually captured image. Therefore, when the AR navigation is used, it is preferable that an image capturing direction of the camera coincides with a traveling direction of the vehicle. Namely, when the image capturing direction of the camera does not coincide with the traveling direction of the vehicle, it is difficult to appropriately perform the AR navigation.

Thus, it is difficult to appropriately apply the techniques in the above Patent References 1 and 2 to the system having the smartphone and the cradle. Specifically, as for the technique in the Patent Reference-1, since the AR navigation starts when the smartphone is attached to the cradle, it can be said that the AR navigation cannot be appropriately perform if the image capturing direction of the camera does not coincide with the traveling direction of the vehicle at that time. Additionally, as for the technique in the Patent Reference-2, the technique determines whether to preferentially display the AR navigation based on the outside condition of the vehicle. However, since the technique does not consider a state in which the image capturing direction of the camera does not coincide with the traveling direction of the vehicle, it can be said that the AR navigation cannot be appropriately perform.

The present invention has been achieved in order to solve the above problem. It is an object of the present invention to provide a terminal device, an image displaying method and an image displaying program executed by a terminal device, capable of appropriately determining whether to preferentially display an actually captured guide image or a map guide image, based on a relationship between an image capturing direction of a camera and a traveling direction of a vehicle.

### Means for Solving the Problem

In the invention according to claim 1, a terminal device mounted on a movable body, includes: an image capturing unit; a determining unit which determines whether to preferentially display an actually captured guide image using a captured image captured by the image capturing unit or a map guide image using map information, based on a relationship between an image capturing direction of the image capturing unit and a traveling direction of the movable body; and a display controlling unit which displays either the actually captured guide image or the map guide image based on a determination by the determining unit.

In the invention according to claim 8, an image displaying method executed by a terminal device which is mounted on a movable body and which includes an image capturing unit, includes: a determining process which determines whether to preferentially display an actually captured guide image using a captured image captured by the image capturing unit or a map guide image using map information, based on a relationship between an image capturing direction of the image capturing unit and a traveling direction of the movable body; and a display controlling process which displays either the actually captured guide image or the map guide image based on a determination by the determining process.

In the invention according to claim 9, an image displaying program executed by a terminal device which is mounted on a movable body and which includes an image capturing unit and a computer, the program makes the computer function as: a determining unit which determines whether to preferentially display an actually captured guide image using a captured image captured by the image capturing unit or a map guide image using map information, based on a relationship between an image capturing direction of the image capturing unit and a traveling direction of the movable body; and a display controlling unit which displays either the actually captured guide image or the map guide image based on a determination by the determining unit.

In the invention according to claim 10, a terminal device, includes: an image capturing unit; a detecting unit which detects a tilt of the terminal device, a determining unit which determines whether to preferentially display an actually captured guide image using a captured image captured by the image capturing unit or a map guide image using map information, based on a relationship between an image capturing direction of the image capturing unit and the tilt of the terminal device; and a display controlling unit which displays either the actually captured guide image or the map guide image based on a determination by the determining unit.

### BRIEF DESCRIPTION OF THE DRAWINGS

FIGS. 1A to 1C illustrate a terminal device in a state held by a terminal holding device.

FIGS. 2A to 2D are diagrams illustrating rotated states of a terminal holder.

FIG. 3 illustrates a schematic configuration of a terminal device.

FIG. 4 illustrates an example of a terminal holding device and a terminal device in a state installed in a vehicle.

FIGS. 5A and 5B show diagrams for explaining a concrete example of a method for determining a difference between an image capturing direction and a traveling direction.

FIG. 6 shows a processing flow executed for starting an application of navigation.

FIG. 7 shows a processing flow executed during a performance of AR navigation.

FIGS. 8A to 8C show diagrams for explaining an example of a method for determining a difference between an image capturing direction and a traveling direction.

FIGS. 9A and 9B show diagrams for explaining a fifth modified example.

### MODE TO EXERCISE THE INVENTION

According to one aspect of the present invention, there is provided a terminal device mounted on a movable body, including: an image capturing unit; a determining unit which determines whether to preferentially display an actually captured guide image using a captured image captured by the image capturing unit or a map guide image using map information, based on a relationship between an image capturing direction of the image capturing unit and a traveling direction of the movable body; and a display controlling unit which displays either the actually captured guide image or the map guide image based on a determination by the determining unit.

The above terminal device is mounted on the movable body, and captures a landscape in front of the movable body by the image capturing unit such as a camera. Additionally, the terminal device has a function of a route guide (navigation) from a present location to a destination. The determining unit determines whether to preferentially display the actually captured guide image using the captured image captured by the image capturing unit or the map guide image using the map information, based on the relationship between the image capturing direction of the image capturing unit and the traveling direction of the movable body. Specifically, the determining unit determines a difference between the image capturing direction and the traveling direction. Then, the display controlling unit displays either the actually captured guide image or the map guide image based on the determination result by the determining unit. By the above terminal device, a guide image to be displayed can be appropriately selected from the actually captured guide image and the map guide image.

In one mode of the above terminal device, the determining unit determines to preferentially display the actually captured guide image when a difference between the image capturing direction and the traveling direction is within a predetermined range, and the determining unit determines to preferentially display the map guide image when the difference is beyond the predetermined range.

According to the mode, when the image capturing direction does not coincide with the traveling direction, it is possible to prevent displaying an inappropriately actually captured guide image. Namely, it is possible to preferentially display the actually captured guide image only when an appropriate actually captured guide image can be displayed.

Preferably, the determining unit can determine the difference between the image capturing direction and the traveling direction based on an image of a white line included in the captured image.

Preferably, the determining unit can obtain an output of a sensor provided in the terminal device and/or a holding device which holds the terminal device, and can determine the difference between the image capturing direction and the traveling direction based on the output of the sensor.

Preferably, the determining unit can determine the difference between the image capturing direction and the traveling direction based on both the output of the above sensor and the image of the white line included in the captured image. Therefore, it becomes possible to accurately determine the difference between the image capturing direction and the traveling direction.

In another mode of the above terminal device, the display controlling unit displays the map guide image when a destination for a route guide is not set. Therefore, the user can set the destination by using the map guide image.

In another mode of the above terminal device, the display controlling unit displays the map guide image while the determining unit performs the determination. According to the mode, when the determination as to whether or not the actually captured guide image can be appropriately displayed is not confirmed, in view of an accommodation of the user, the display controlling unit can display the map guide image instead of the actually captured guide image.

In another mode of the above terminal device, when the terminal device is operated during displaying the actually captured guide image, the display controlling unit switches the actually captured guide image to the map guide image. Since the image capturing direction tends to change when the terminal device is operated, there is a possibility that the actually captured guide image cannot be appropriately displayed. Hence, the display controlling unit switches the actually captured guide image to the map guide image.

According to another aspect of the present invention, there is provided an image displaying method executed by a terminal device which is mounted on a movable body and which includes an image capturing unit, including: a determining process which determines whether to preferentially display an actually captured guide image using a captured image captured by the image capturing unit or a map guide image using map information, based on a relationship between an image capturing direction of the image capturing unit and a traveling direction of the movable body; and a display controlling process which displays either the actually captured guide image or the map guide image based on a determination by the determining process.

According to still another aspect of the present invention, there is provided an image displaying program executed by a terminal device which is mounted on a movable body and which includes an image capturing unit and a computer, the program makes the computer function as: a determining unit which determines whether to preferentially display an actually captured guide image using a captured image captured by the image capturing unit or a map guide image using map information, based on a relationship between an image capturing direction of the image capturing unit and a traveling direction of the movable body; and a display controlling unit which displays either the actually captured guide image or the map guide image based on a determination by the determining unit.

Also by the image displaying method and the image displaying program described above, the guide image to be displayed can be appropriately selected from the actually captured guide image and the map guide image.

According to still another aspect of the present invention, there is provided a terminal device, including: an image capturing unit; a detecting unit which detects a tilt of the terminal device, a determining unit which determines whether to preferentially display an actually captured guide image using a captured image captured by the image capturing unit or a map guide image using map information, based on a relationship between an image capturing direction of the image capturing unit and the tilt of the terminal device; and a display controlling unit which displays either the actually captured guide image or the map guide image based on a determination by the determining unit.

By the above terminal device, when the user uses and carries the terminal device (for example, a pedestrian utilizes the route guide by using the terminal device), the guide image to be displayed can be appropriately selected from the actually captured guide image and the map guide image.

In one mode of the above terminal device, the detecting unit detects a tilt of the image capturing direction with respect to a horizontal plane, as the tilt of the terminal device, the determining unit determines to preferentially display the actually captured guide image when the tilt of the image capturing direction with respect to the horizontal plane is within a predetermined range, and the determining unit determines to preferentially display the map guide image when the tilt of the image capturing direction with respect to the horizontal plane is beyond the predetermined range.

### Embodiment

The preferred embodiments of the present invention will now be described below with reference to the drawings.

[Device Configuration]

First, a configuration of a terminal device according to this embodiment will be described.

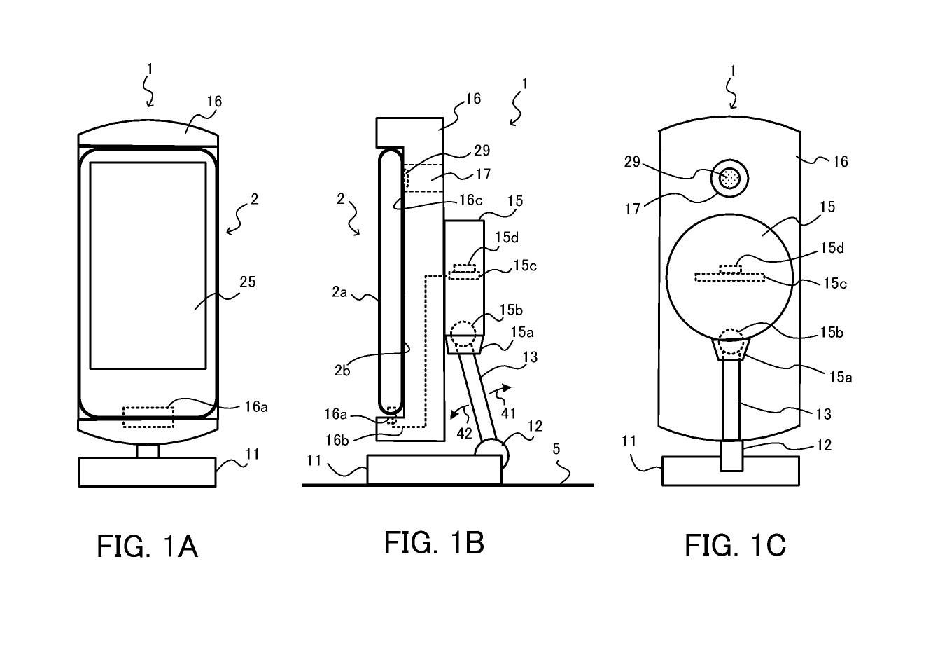

FIGS. 1A to 1C illustrate the terminal device 2 in such a state that it is held by a terminal holding device 1. FIG. 1A is a front view, FIG. 1B is a side view, and FIG. 1C is a rear view.

The terminal holding device 1 mainly includes a base 11, a hinge 12, an arm 13, a substrate holder 15 and a terminal holder 16. The terminal holding device 1 functions as a so-called cradle, to which the terminal device 2 such as a smartphone is attached.

The base 11 functions as a base used when the terminal holding device 1 is attached to a movable body such as a vehicle. For example, the base 11 is provided with a sucker or an adhesive tape at its underside, and the base 11 is fixed to an installation surface 5 such as a dashboard of the vehicle by the adhesive tape.

The arm 13 is fixed to hinge 12, and is attached to the base 11 in a manner rotatable with respect to the base 11. By the rotation of the hinge 12, the arm 13 swings in a front-rear direction of the terminal device 2, i.e., in a direction of the arrows 41 and 42 in FIG. 1B. Namely, by rotating the arm 13 via the hinge 12 with respect to the base 11 fixed to the installation surface 5 of the vehicle, it is possible to adjust the installation angle of the substrate holder 15 and the terminal holder 16 with respect to the installation surface 5.

The substrate holder 15 includes a cover 15a, a ball link 15b, a sensor substrate 15c and a sensor 15d. The ball link 15b is attached to an upper end of the arm 13, and holds the substrate holder 15 at an arbitrary angle with respect to the arm 13. The cover 15a is provided at a lower end of the substrate holder 15, and has a function of restricting the rotation of the substrate holder 15 with respect to the arm 13. The sensor substrate 15c is provided inside of the substrate holder 15, and the sensor substrate 15c is provided with the sensor 15d. A preferred example of the sensor 15d is a gyro sensor which detects an angular velocity about a horizontal axis of the movable body and/or acceleration.

The terminal holder 16 is a holder which holds the terminal device 2. The terminal holder 16 includes a connector 16a and a wiring 16b. The connector 16a is provided at the bottom of the front surface, i.e., the surface on which the terminal device 2 is set, and is connected to the connector of the terminal device 2 when the terminal device 2 is set to the terminal holder 16. The connector 16a is electrically connected to the sensor substrate 15c via the wiring 16b. Therefore, the detection signal of the sensor 15d is supplied to the terminal device 2 via the sensor substrate 15c, the wiring 16b and the connector 16a.

The terminal device 2 includes a front surface 2a, which is a front side of the body of the terminal device 2 and includes a display unit 25 such as an LCD panel, and a rear surface 2b which is a rear side of the body of the terminal device 2. Normally, the terminal device 2 is formed in a rectangular flat-plate shape, and the front surface 2a and the rear surface 2b are substantially parallel with each other.

The terminal holder 16 has a contact surface 16c at its front side. When the terminal device 2 is attached to the terminal holder 16, the contact surface 16c contacts and supports the rear surface 2b of the terminal device 2. In the example shown in FIGS. 1A and 1B, the contact surface 16c of the terminal holder 16 is formed such that its entire surface contacts the rear surface 2b of the terminal device 2. Instead, it is possible to employ such a configuration that one or plural parts of the contact surface 16c is formed to be partly protruding, and only the protruding parts contact the rear surface 2b of the terminal device 2.

On the rear surface 2b of the terminal device, a camera 29 is provided. Also, the terminal holder 16 of the terminal holding device 1 is formed with a hole 17 at the position confronting the camera 29 when the terminal device 2 is held by the terminal holding device 1. The hole 17 has a diameter larger than the diameter of the lens of the camera 29. Thus, in a state that the terminal device 2 is held by the terminal holder 1, the camera 29 is not suffered from the outer wall of the terminal holder 16 and can capture image behind the terminal holder 16. Specifically, the camera 29 captures image outside the vehicle.

In the example shown in FIGS. 1B and 1C, the terminal holder 16 is configured to cover substantially entire area of the rear surface 2b of the terminal device 2 and is formed with the hole 17 at the position confronting the camera 29 of the terminal device 2. Instead, the terminal holder 16 may be configured to cover only the area lower than the position of the camera 29 of the terminal device 2 when the terminal device 2 is held by the terminal holding device 1. In one example, the contact surface 16c of the terminal holder 16 may be formed into a shape extending to the position lower than the position at which the camera 29 of the terminal device 2 is provided (i.e., a shape in which the contact surface 16c does not exist above the position at which the camera 29 of the terminal device 2 is provided). In such an example, it is not necessary to form the hole 17 on the terminal holding device 1.

While the camera 29 is provided substantially on the center line in the left-right direction of the rear surface 2b of the terminal device 2, it is not limited that the camera 29 is provided at such a position. For example, the camera 29 may be provided at a position shifted, to some extent, from the center line in the left-right direction of the rear surface 2b. In this case, instead of forming the hole 17 on the terminal holder 16, a cutout may be formed at a part including the position of the camera 29 of the terminal device 2 when the terminal device 2 is held by the terminal holding device 1.

Next, the rotation function of the terminal holder 30 with respect to the substrate holder 20 will be described. The terminal holder 30 holding the terminal device 50 is rotatable, by the unit of 90 degrees, with respect to the substrate holder 20. Namely, when the state shown in FIG. 1A is defined as the rotation angle 0 degree, the terminal holder 30 can be fixed in four states being rotated by 0 degree, 90 degrees, 180 degrees and 270 degrees in a clockwise or counterclockwise direction. The reason why it can be fixed by the unit of 90 degrees is that a user normally uses the terminal device 50 in such a state that the display unit is arranged vertically or laterally, when the user sees the display unit. As described above, the terminal device 50 normally has a rectangular flat-plate shape. “Arranging vertically” means such an arrangement that the longitudinal direction of the display unit is vertical, and “arranging laterally” means such an arrangement that the longitudinal direction of the display unit is lateral.

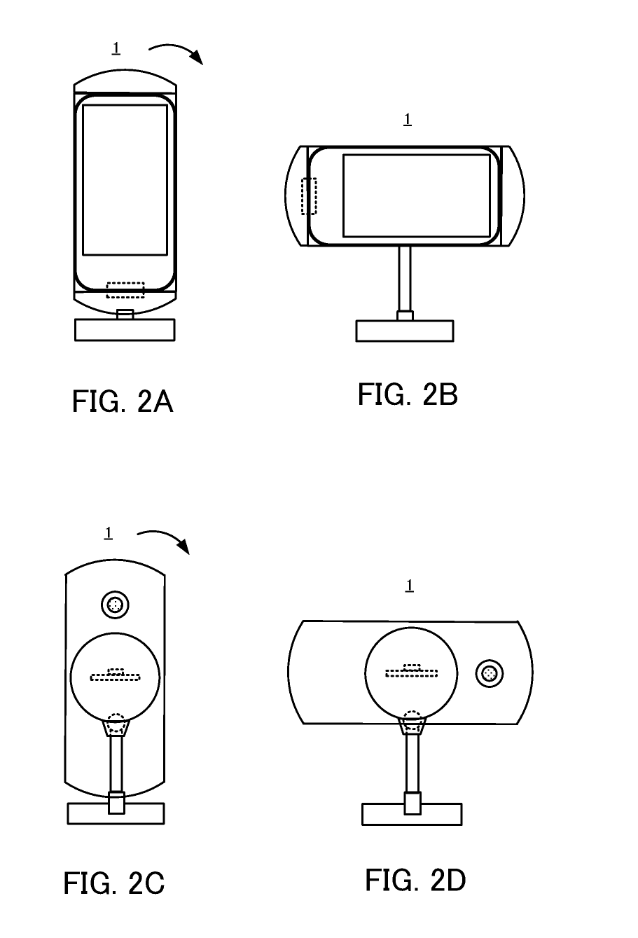

FIGS. 2A to 2D illustrate the states in which the terminal holder 30 is rotated. When the terminal holding device 1 is observed from the front side, rotating the terminal holder 30 by 90 degrees in the direction of the arrow from the state of FIG. 2A results in the state of FIG. 2B. When the terminal holding device is observed from the rear side, rotating the terminal holder 30 in the direction of the arrow from the state of FIG. 2C results in the state of FIG. 2D.

Structurally, by providing a rotational axis (not shown) at a substantial center of the substrate holder 20 and fixing the terminal holder 30 to the rotational axis, the terminal holder 30 becomes rotatable with respect to the substrate holder 20. Also, by providing pairs of concavity-convexity or recess-protrusion engage with each other at the positions of every 90-degree rotation angles, to the surface where the substrate holder 20 and the terminal holder 30 abut with each other, the terminal holder 30 can be fixed at the positions of every 90-degree rotation angles. The above-described structure is merely an example, and other structure may be employed as long as the terminal holder 30 can be fixed to the substrate holder 20 at every 90-degree rotation angles.

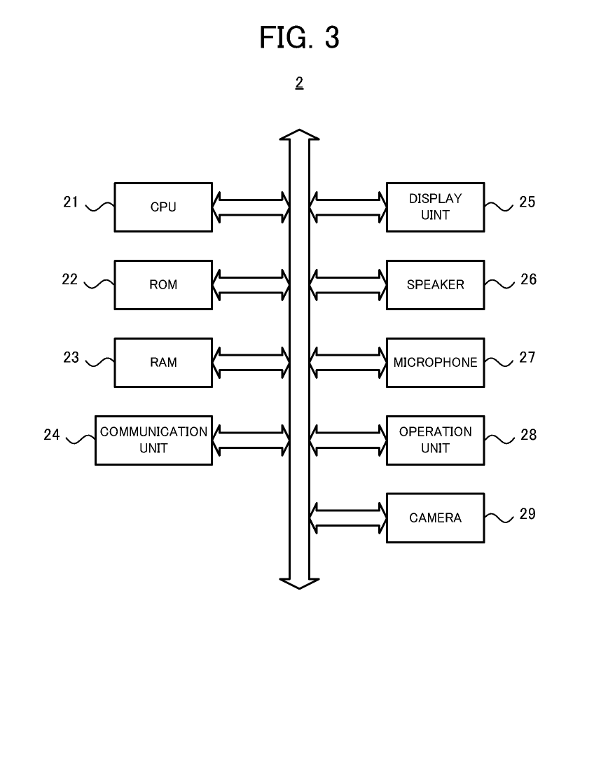

FIG. 3 schematically illustrates a configuration of the terminal device 2. As illustrated in FIG. 3, the terminal device 2 mainly includes a CPU 21, a ROM 22, a RAM 23, a communication unit 24, a display unit 25, a speaker 26, a microphone 27, an operation unit 28 and the camera 29. The terminal device 2 is a portable-type terminal device such as a smartphone having a telephone call function. For example, the terminal device 2 is installed at a position on the dashboard where a driver of the vehicle can see the display unit 25, in a state held by the terminal holding device 1.

The CPU (Central Process Unit) 21 executes control of the terminal device 2 in its entirety. For example, the CPU 21 obtains map information, and executes a processing for a route guide (navigation) to a destination. In this case, the CPU 21 makes the display unit 25 display a guide image for the route guide. The said guide image is an actually captured guide image or a map guide image, which are described later.

The ROM (Read Only Memory) 22 has a non-volatile memory, not shown, storing control program for controlling the terminal device 2. The RAM (Random Access Memory) 23 stores data set by a user via the operation unit 26 in a readable manner, and provides a working area for the CPU 21. A storage unit other than the ROM 22 and the RAM 23 may be provided in the terminal device 2, and the said storage unit may store various data used by the route guide processing, such as the map information and a facility data.

The communication unit 24 is configured to be able to perform wireless communication with other terminal device 2 via a communication network. Additionally, the communication unit 24 is configured to be able to perform wireless communication with servers such as a VICS center. The communication unit 24 can receive data such as the map information and traffic jam information, from the servers.

The display unit 25 may be a liquid crystal display, and displays characters and images to the user. The speaker 26 outputs sounds to the user. The microphone 27 collects voices spoken by the user.

The operation unit 28 may be operation buttons or a touch panel type input device provided on a casing of the terminal device 2, to which various selections and instructions by the user is inputted. If the display unit 25 is a touch panel type, the touch panel provided on the display screen of the display unit 25 may function as the operation unit 28.

The camera 29 may be a CCD camera, for example, and is provided on the rear surface 2b of the terminal device 2 as illustrated in FIGS. 1B and 1C. Basically, the direction of the optical axis (an axis extending vertically from the center of the lens) of the camera 29 coincides with the vertical direction of the rear surface of the terminal device 2 (i.e., the normal direction). The camera 29 may be provided, not only on the rear surface 2b of the terminal device 2, but also on the front surface 2a of the terminal device 2.

The camera 29 corresponds to an example of an image capturing unit of the present invention, and the CPU 21 corresponds to an example of a determining unit and a display controlling unit (the detail will be described later).

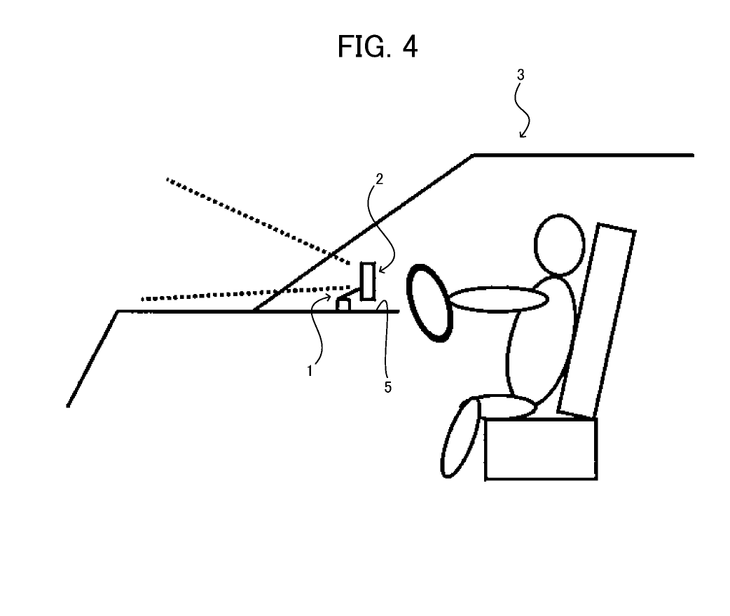

FIG. 4 illustrates an example of the terminal holding device 1 and the terminal device 2 in a state installed in the vehicle 3. As shown in FIG. 4, the terminal holding device 1 is fixed to an installation surface 5 such as a dashboard of the vehicle 3, and the terminal device 2 is held by the terminal holding device 1 in a state fixed to the installation surface 5. Additionally, as shown by a broken line in FIG. 4, the terminal device 2 captures the traveling direction of the vehicle 3 by the camera 29.

In the specification, the “image capturing direction” of the camera 29 means the direction of the camera 29. Concretely, the “image capturing direction” corresponds to the optical axis direction of the lens of the camera 29. Additionally, in the specification, the “traveling direction” of the vehicle 3 means the front-rear direction (specifically the front direction) of the vehicle 3. The “traveling direction” includes not only the direction in which the vehicle 3 actually travels but also the direction in which the vehicle 3 will travel (i.e., the direction in which the vehicle 3 is expected to travel). It is not necessary that the vehicle 3 travels in defining the “traveling direction”. Namely, the vehicle 3 may stop traveling.

[Display Controlling Method]

Next, a description will be given of a display controlling method in the embodiment. In the embodiment, the CPU 21 in the terminal device 2 executes a processing for switching between the actually captured guide image using the captured image (actually captured image) by the camera 29 and the map guide image (hereinafter arbitrarily referred to as “normal map image”) using the map information, when the route guide to the destination is performed. In other words, the CPU 21 switches between the AR navigation using the captured image by the camera 29 and the normal navigation using the map information, when the route guide is performed. In this case, the CUP 21 performs the above switching based on a relationship between the image capturing direction of the camera 29 and the traveling direction of the vehicle 3.

The “map guide image (normal map image)” corresponds to a map image around the position of the vehicle 3, which is generated based on the map information. Additionally, the “map guide image (normal map image)” includes not only an image in which an image for the route guide is displayed on the said map image (for example, an image in which the searched road is emphatically displayed) but also an image in which only the said map image is displayed without displaying the image for the route guide.

Here, a brief description will be given of a reason for performing the above switching. As mentioned above, there is known the AR navigation which performs the route guide by using the image in front of the vehicle 3 which is captured by the camera 29 of the terminal device 2 in such a state that the terminal device 2 is mounted on the vehicle 3 by the terminal holding device 1. The AR navigation displays the image for the route guide, such as the direction and the distance to the destination, in a manner superimposed on the captured image of the camera 29. The displayed image corresponds to the above actually captured guide image. Therefore, it is preferable that the image capturing direction of the camera 29 coincides with the traveling direction of the vehicle 3 in order to appropriately perform the AR navigation. Namely, when the image capturing direction of the camera 29 does not coincide with the traveling direction of the vehicle 3, it is difficult to appropriately perform the AR navigation.

In consideration of the above matter, in such a state that the AR navigation cannot be appropriately performed (specifically, in such a state that it can be determined that the image capturing direction of the camera 29 does not coincide with the traveling direction of the vehicle 3), the embodiment does not perform the AR navigation, i.e., the embodiment does not display the actually captured guide image. In order to realize this, based on the relationship between the image capturing direction of the camera 29 and the traveling direction of the vehicle 3, the CPU 21 in the terminal device 2 determines whether to preferentially display the actually captured guide image or the map guide image, i.e., the CPU 21 determines whether to preferentially perform the AR navigation or the normal navigation. Specifically, when it is determined that a difference between the image capturing direction and the traveling direction is within a predetermined range, the CPU 21 determines to preferentially display the actually captured guide image. When it is determined that the difference between the image capturing direction and the traveling direction is beyond the predetermined range, the CPU 21 determines to preferentially display the map guide image. For example, the “predetermined range” used in the said determination is preliminarily set based on a point of view as to whether or not the AR navigation can be appropriately performed.

Next, a description will be given of a concrete example of the method for determining the difference between the image capturing direction of the camera 29 and the traveling direction of the vehicle 3.

The CPU 21 in the terminal device 2 recognizes an image of a white line on a road in the captured image by executing an image processing of the captured image by the camera 29, and determines the difference between the image capturing direction of the camera 29 and the traveling direction of the vehicle 3 based on the image of the white line. As an example, the CPU 21 uses multiple captured images which are obtained when the vehicle 3 travels a certain distance after a start of traveling, and determines the difference between the image capturing direction and the traveling direction based on a change of the image of the white line in the multiple captured images. In this example, when the image of the white line in the multiple captured images hardly changes (for example, when amount of a position change of the while line or amount of an angle change of the while line is smaller than a predetermined value), the CPU 21 determines that the image capturing direction substantially coincides with the traveling direction. In this case, the CPU 21 determines that the difference between the image capturing direction and the traveling direction is within the predetermined range, and determines to preferentially display the actually captured guide image.

Meanwhile, when the image of the white line in the multiple captured images changes (for example, when the amount of the position change of the while line or the amount of the angle change of the while line is equal to or larger than the predetermined value), the CPU 21 determines that the image capturing direction does not coincide with the traveling direction. Additionally, when the multiple captured images do not include the image of the white line, the CPU 21 determines that the image capturing direction does not coincide with the traveling direction. In this case, the CPU 21 determines that the difference between the image capturing direction and the traveling direction is beyond the predetermined range, and determines to preferentially display the map guide image.

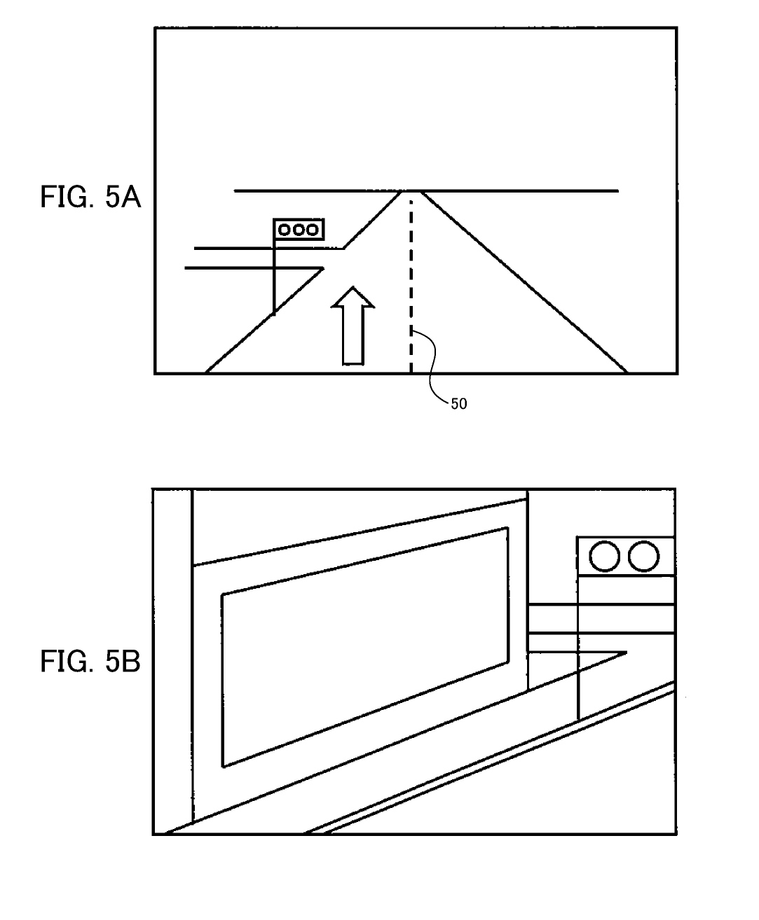

Next, a description will be given of an application example of the above method for determining the difference between the image capturing direction and the traveling direction, with reference to FIGS. 5A and 5B. FIGS. 5A and 5B show examples of the captured image by the camera 29. Specifically, FIG. 5A shows an example of the captured image which is captured when the image capturing direction of the camera 29 substantially coincides with the traveling direction of the vehicle 3, and FIG. 5B shows an example of the captured image which is captured when the image capturing direction of the camera 29 does not coincide with the traveling direction of the vehicle 3.

When the captured image as shown in FIG. 5A is obtained, since an image 50 of the white line in the captured image hardly changes, the CPU 21 determines that the difference between the image capturing direction and the traveling direction is within the predetermined range. Meanwhile, when the captured image as shown in FIG. 5B is obtained, since the captured image does not include the image of the white line, the CPU 21 determines that the difference between the image capturing direction and the traveling direction is beyond the predetermined range. The captured images shown in FIGS. 5A and 5B are used for determining the difference between the image capturing direction and the traveling direction. Hence, basically, the captured images are not displayed on the display unit 25 during the determination.

Thus, according to the embodiment, by appropriately determining the difference between the image capturing direction of the camera 29 and the traveling direction of the vehicle 3, the guide image to be displayed can be appropriately selected from the actually captured guide image and the map guide image. Therefore, in such a state that the image capturing direction of the camera 29 does not coincide with the traveling direction of the vehicle 3, it is possible to prevent displaying an inappropriately actually captured guide image. Namely, according to the embodiment, it is possible to preferentially display the actually captured guide image only when an appropriately actually captured guide image can be displayed.

It is not limited to determine the difference between the image capturing direction and the traveling direction based on the change of the white line in the multiple captured images. As another example, the difference between the image capturing direction and the traveling direction may be determined based on a position or an angle of the white line in the captured image.

In the example, when the white line is located in a predetermined area of the captured image, or when a tilt of the white line corresponds to an angle within a predetermined range, the CPU 21 determines that the difference between the image capturing direction and the traveling direction is within the predetermined range. Meanwhile, when the white line is not located in the predetermined area of the captured image, or when the tilt of the white line does not correspond to the angle within the predetermined range, the CPU 21 determines that the difference between the image capturing direction and the traveling direction is beyond the predetermined range.

Even when the CPU 21 determines to preferentially display an arbitrary guide image based on the difference between the image capturing direction and the traveling direction, there is a case that the said guide image is not displayed depending on a setting by the user. For example, even when the CPU 21 determines to preferentially display the actually captured guide image since the difference between the image capturing direction and the traveling direction is within the predetermined range, the CPU 21 displays the map guide image instead of the actually captured guide image when a setting for automatically switching to the AR navigation is set to off.

[Processing Flow]

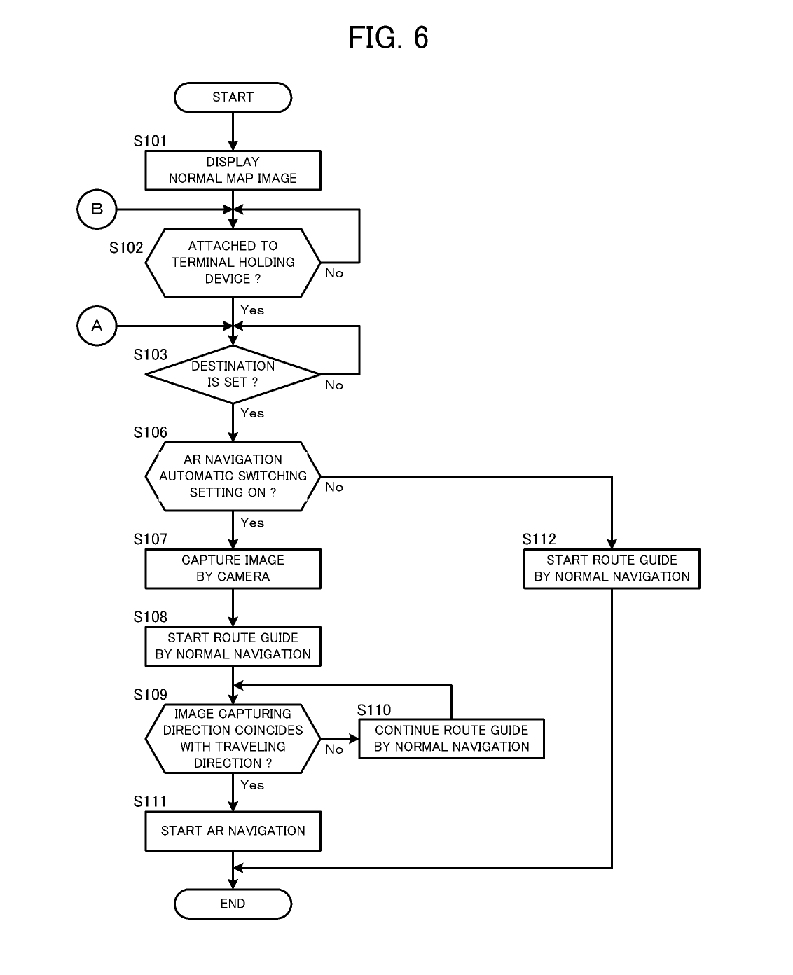

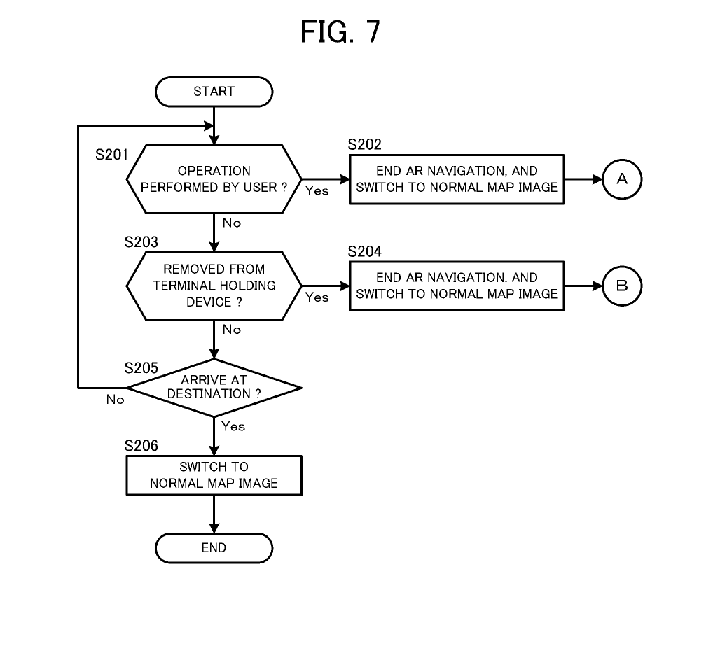

Next, a description will be given of processing flows executed by the CPU 21 in the embodiment, with reference to FIG. 6 and FIG. 7.

FIG. 6 shows a processing flow executed for starting an application of the navigation (AR navigation or normal navigation) in the embodiment. The said processing flow is realized by the CPU 21 in the terminal device 2, which executes the program stored in the ROM 22.

First, in step S101, the CPU 21 displays the normal map image on the display unit 25. Specifically, the CPU 21 generates the normal map image based on the map information obtained by the server via the communication unit 24 and/or the map information stored in the storage unit, so as to display the normal map image on the display unit 25. The reason for displaying the normal map image instead of the actually captured guide image at the time of starting the processing flow is that the user is made to perform the operation for setting the destination on the normal map image, for example. Additionally, the reason is that it is considered unnecessary to display the actually captured guide image at the time of starting the processing flow. After step S101, the processing goes to step S102.

In step S102, the CPU 21 determines whether or not the terminal device 2 is attached to the terminal holding device 1. For example, the terminal holding device 1 is provided with a sensor which detects the attachment and the removal of the terminal device 2, and the CPU 21 obtains an output signal of the sensor so as to execute the determination in step S102. When the terminal device 2 is attached to the terminal holding device 1 (step S102: Yes), the processing goes to step S103. When the terminal device 2 is not attached to the terminal holding device 1 (step S102: No), the processing returns to step S102.

In step S103, the CPU 21 determines whether or not the destination is set. Specifically, the CPU 21 determines whether or not the user operates the operation unit 28 in order to input the destination. The reason for performing the determination is that the setting of the destination is one of conditions for starting the route guide. When the destination is set (step S103: Yes), the processing goes to step S106. When the destination is not set (step S103: No), the processing returns to step S103.

The CPU 21 may reverse the order of execution of the determination in step S102 and the determination in step S103. Namely, the CPU 21 may determine whether or not the terminal device 2 is attached to the terminal holding device 1, after determining whether or not the destination is set (specifically, when the CPU 21 determines that the destination is set).

In step S106, the CPU 21 determines whether or not an AR navigation automatic switching setting is on. Namely, the CPU 21 determines whether or not the setting for automatically switching to the AR navigation is set to on by the user. When the AR navigation automatic switching setting is on (step S106: Yes), the processing goes to step S107.

In step S107, the CPU 21 makes the camera 29 capture the image by controlling the camera 29. Then, the CPU 21 obtains the captured image by the camera 29. Afterward, the processing goes to step S108. Here, the CPU 21 internally performs the image processing of the captured image without displaying the captured image on the display unit 25 until the AR navigation is started. Namely, while the captured image is used for determining the difference between the image capturing direction of the camera 29 and the traveling direction of the vehicle 3, the CPU 21 does not display the captured image during the determination. During the determination, the CPU 21 displays the normal map image.

In step S108, the CPU 21 starts the route guide by the normal navigation. Specifically, the CPU 21 searches the route from the present location to the destination based on the map information, and displays the map guide image (normal map image) in accordance with the searched route, on the display unit 25. The reason for staring the route guide by the normal navigation though the AR navigation automatic switching setting is on is that the determination as to whether or not the AR navigation can be appropriately performed is not confirmed. Namely, when the determination as to whether or not the AR navigation can be appropriately performed is not confirmed, in view of an accommodation of the user, it is preferable to display the normal map guide image instead of the actually captured guide image. After step S108, the processing goes to step S109.

The CPU 21 may reverse the order of execution of the processing in step S107 and the processing in step S108. Namely, the CPU 21 may make the camera 29 capture the image after starting the route guide by the normal navigation. As another example, the CPU 21 may simultaneously execute the processing in step S107 and the processing in step S108. Namely, the CPU 21 may make the camera 29 capture the image at the same time starting the route guide by the normal navigation.

In step S109, the CPU 21 determines whether or not the image capturing direction of the camera 29 coincides with the traveling direction of the vehicle 3. In other words, the CPU 21 determines whether or not the difference between the image capturing direction and the traveling direction is within the predetermined range. For example, the CPU 21 recognizes the image of the white line on the road in the captured image by executing the image processing of the captured image, and determines the difference between the image capturing direction and the traveling direction based on the image of the white line. In the example, the CPU 21 uses the multiple captured images which are obtained when the vehicle 3 travels a certain distance, and determines the difference between the image capturing direction and the traveling direction based on the change of the white line in the multiple captured images. When the image of the white line in the multiple captured images hardly changes, the CPU 21 determines that the image capturing direction substantially coincides with the traveling direction (step S109: Yes). In other words, the CPU 21 determines that the difference between the image capturing direction and the traveling direction is within the predetermined range. In this case, the CPU 21 determines that the AR navigation can be appropriately performed, and starts the AR navigation (step S111). Specifically, the CPU 21 displays the actually captured guide image in which the image for the route guide is superimposed on the captured image by the camera 29, on the display unit 25. Then, the processing ends.

Meanwhile, when the image of the white line in the multiple captured images changes, the CPU 21 determines that the image capturing direction does not coincide with the traveling direction (step S109: No). In other words, the CPU 21 determines that the difference between the image capturing direction and the traveling direction is beyond the predetermined range. In this case, the CPU 21 continues the route guide by the normal navigation (step S110). In other words, the CPU 21 continues to display the normal map image. Then, the processing returns to step S109. Namely, until the image capturing direction substantially coincides with the traveling direction (specifically, until the image capturing direction substantially coincides with the traveling direction by an adjustment of the image capturing direction by the user), the CPU 21 repeatedly executes the processing in step S109 and the processing step S110. When the normal map image continues to be displayed despite the AR navigation automatic switching setting, the user can understand that the image capturing direction does not coincide with the traveling direction, and can adjust the image capturing direction. The user can adjust the image capturing direction by seeing a type of a guide screen displayed on the display unit 25.

On the other hand, when the AR navigation automatic switching setting is not on (step S106: No), the processing goes to step S112. In step S112, similar to the above step S108, the CPU 21 starts the route guide by the normal navigation. Then, the processing ends. The normal navigation is performed until the vehicle 3 arrives at the destination.

Next, a description will be given of a processing flow executed during the performance of the AR navigation, with reference to FIG. 7. Specifically, the said processing is executed after the above step S111. The said processing flow is realized by the CPU 21 in the terminal device 2, which executes the program stored in the ROM 22, too.

First, in step S201, the CPU 21 determines whether or not the operation of the terminal device 2 is performed by the user. Namely, the CPU 21 determines whether or not the user operates the operation unit 28 during the performance of the AR navigation. For example, the CPU 21 determines whether or not an operation for pushing a switching button used for switching the actually captured guide image to the normal map image and/or an operation for pushing a button used for resetting the destination is performed. When the operation of the terminal device 2 is performed (step S201: Yes), the processing goes to step S202.

In step S202, the CPU 21 ends the AR navigation, and switches the display image from the actually captured guide image to the normal map image. The reason will be described below. First, this is because, when the switching button used for switching the actually captured guide image to the normal map image is pushed, it is thought that the actually captured guide image should be immediately switched to the normal map image. Additionally, this is because, when the button used for resetting the destination is pushed instead of the switching button, it is thought that it is preferable to make the user perform the operation for resetting the destination on the normal map image. Additionally, this is because, when any one of the buttons of the terminal device 2 is operated, there is a tendency that the image capturing direction of the camera 29 changes, and that the image capturing direction does not coincide with the traveling direction. Namely, there is a possibility that the actually captured guide image cannot be appropriately displayed.

After step S202, the processing goes to step S103 shown in FIG. 6. In this case, similar to the procedure shown in FIG. 6, the processing after step S103 is executed. This is because, when the operation of the terminal device 2 is performed, it is preferable that the determination as to whether or not the destination is set (step S103) and the determination as to whether or not the image capturing direction of the camera 29 substantially coincides with the traveling direction of the vehicle 3 (step S109) are performed again. Namely, this is because, when the operation of the terminal device 2 is performed, it is preferable that the user is made to perform the setting of the destination, the adjustment of the tilt of the terminal holding device 1 and the adjustment of the image capturing direction of the camera 29 again.

Meanwhile, when the operation of the terminal device 2 is not performed (step S201: No), the processing goes to step S203. In step S203, the CPU 21 determines whether or not the terminal device 2 is removed from the terminal holding device 1. For example, the terminal holding device 1 is provided with the sensor which detects the attachment and the removal of the terminal device 2, and the CPU 21 obtains the output signal of the sensor so as to execute the determination in step S203. When the terminal device 2 is removed from the terminal holding device 1 (step S203: Yes), the processing goes to step S204.

In step S204, the CPU 21 ends the AR navigation, and switches the display image from the actually captured guide image to the normal map image. This is because, when the terminal device 2 is removed from the terminal holding device 1, it is unlikely that the user utilizes the route guide by referring to the actually captured guide image. Namely, this is because it is considered unnecessary to display the actually captured guide image.

After step S204, the processing goes to step S102 shown in FIG. 6. Namely, the determination as to whether or not the terminal device 2 is attached to the terminal holding device 1 (step S102) is performed again. Then, when the terminal device 2 is attached to the terminal holding device 1 (step S102: Yes), similar to the procedure shown in FIG. 6, the processing after step S103 is executed. This is because, when the terminal device 2 is attached to the terminal holding device 1 after being removed from the terminal holding device 1, it is preferable that the determination as to whether or not the destination is set (step S103) and the determination as to whether or not the image capturing direction of the camera 29 substantially coincides with the traveling direction of the vehicle 3 (step S109) are performed again. Namely, this is because, when the terminal device 2 is attached to the terminal holding device 1 after being removed from the terminal holding device 1, it is preferable that the user is made to perform the adjustment of the tilt of the terminal holding device 1 and the adjustment of the image capturing direction of the camera 29 again.

Meanwhile, when the terminal device 2 is not removed from the terminal holding device 1 (step S203: No), the processing goes to step S205. In step S205, the CPU 21 determines whether or not the vehicle 3 arrives at the destination. When the vehicle 3 arrives at the destination (step S205: Yes), the CPU 21 ends the AR navigation, and switches the display image from the actually captured guide image to the normal map image (step S206). Then, the processing ends. In contrast, when the vehicle 3 does not arrive at the destination (step S205: No), the processing returns to step S201.

According to the above processing flow, the guide image to be displayed can be appropriately selected from the actually captured guide image and the map guide image (normal map image). Specifically, without the switching operation by the user, it is possible to preferentially display the appropriate guide screen in accordance with the state automatically.

### MODIFIED EXAMPLES

Next, a description will be given of modified examples.

### First Modified Example

The above embodiment determines the difference between the image capturing direction and the traveling direction based on the image of the white line on the road in the captured image. A first modified example determines the difference between the image capturing direction and the traveling direction based on a proportion of an image of the road in the captured image instead of the white line in the captured image. Specifically, in the first modified example, the CPU 21 calculates the proportion of the image of the road in the captured image by analyzing the captured image, and determines the difference between the image capturing direction and the traveling direction by comparing the calculated proportion with a predetermined value. When the calculated proportion is equal to or larger than the predetermined value, the CPU 21 determines that the difference between the image capturing direction and the traveling direction is within the predetermined range, and determines to preferentially display the actually captured guide image. Meanwhile, when the calculated proportion is smaller than the predetermined value, the CPU 21 determines that the difference between the image capturing direction and the traveling direction is beyond the predetermined range, and determines to preferentially display the map guide image.

### Second Modified Example

A second modified example determines the difference between the image capturing direction and the traveling direction based on a position of the image of the road in the captured image, instead of the white line in the captured image and the proportion of the image of the road in the captured image. Specifically, in the second modified example, the CPU 21 recognizes the image of the road in the captured image by analyzing the captured image, and determines the difference between the image capturing direction and the traveling direction, depending on whether or not the said image of the road is located in a predetermined area of the captured image. When the image of the road is located in the predetermined area of the captured image (for example, when the image of the road is substantially located in a central area of the captured image), the CPU 21 determines that the difference between the image capturing direction and the traveling direction is within the predetermined range, and determines to preferentially display the actually captured guide image. Meanwhile, when the image of the road is not located in the predetermined area of the captured image (for example, when the image of the road is located in an area at the end of the captured image), the CPU 21 determines that the difference between the image capturing direction and the traveling direction is beyond the predetermined range, and determines to preferentially display the map guide image.

### Third Modified Example

A third modified example determines the difference between the image capturing direction and the traveling direction based on an output of a sensor provided in the terminal device 2 and/or the terminal holding device 1, instead of determining the difference between the image capturing direction and the traveling direction by analyzing the captured image as shown in the embodiment and the first and second modified examples. Specifically, in the third modified example, the CPU 21 determines the difference between the image capturing direction and the traveling direction based on an output of a sensor which detects a traveling condition of the vehicle 3 (for example, a velocity, acceleration and a position). As an example, the CPU 21 calculates the traveling direction based on an output of a sensor which can detect at least a velocity in two-dimensional directions, so as to determine the difference between the image capturing direction and the traveling direction. It is not limited to use a sensor which directly detects the velocity. A sensor which indirectly detects the velocity may be used.

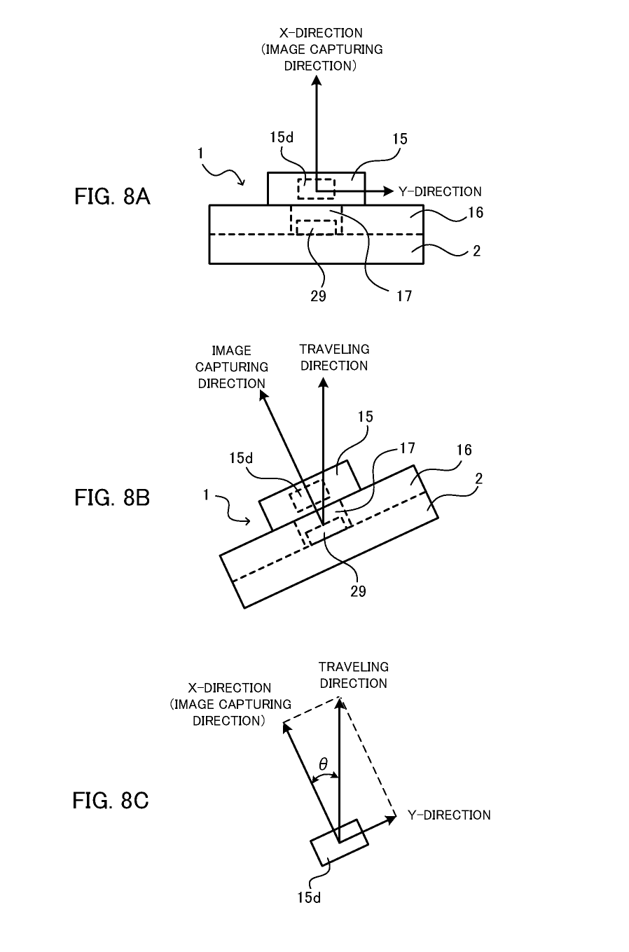

Here, a description will be given of an example of the method for determining the difference between the image capturing direction and the traveling direction, with reference to FIGS. 8A to 8C.

FIG. 8A illustrates a view of the terminal device 2 in a state held by the terminal holding device 1 observed from upside thereof. In FIG. 8A, for convenience of explanation, the terminal holding device 1 and the terminal device 2 are illustrated in a simplified manner. As illustrated in FIG. 8A, the sensor 15d is provided in the substrate holder 15 of the terminal holding device 1. The sensor 15d is an acceleration sensor (i.e., G sensor) configured to be able to detect acceleration in two-dimensional directions. In the following description, the “sensor 15d” will be expressed as the “acceleration sensor 15d”. As described above, in the state that the terminal device 2 is held by the terminal holding device 1 (specifically, in the state that the connector of the terminal device 2 is connected with the connector 16a in the terminal holder 16), the output signal of the acceleration sensor 15d is supplied to the terminal device 2 via the sensor substrate 15c in the substrate holder 15 and the wiring 16b and the connector 16a in the terminal holder 16. In this case, the CPU 21 in the terminal device 2 obtains the output signal of the acceleration sensor 15d.

Specifically, the acceleration sensor 15d detects the acceleration in the X-direction and the Y-direction as shown in FIG. 8A. Since the acceleration sensor 15d is fixed to the terminal holding device 1 and its positional relation with the camera 29 of the terminal device 2 attached to the terminal holding device 1 is constant, the X-direction and Y-direction in which the acceleration sensor 15d detects the acceleration have a constant relation with the image capturing direction of the camera 29. As illustrated in FIG. 8A, the X-direction and the image capturing direction coincide.

While FIG. 8B illustrates the terminal device 2 in the state held by the terminal holding device 1 similarly to FIG. 8A, FIG. 8B illustrates the state that the terminal device 2 is not directed to the traveling direction of the vehicle 3, i.e., the state that the image capturing direction of the camera 29 does not coincide with the traveling direction of the vehicle 3. In a state that the terminal device 2 is held by the terminal holding device 1, the direction of the terminal holding device 1 coincides with the direction of the terminal device 2. Therefore, by the acceleration sensor 15d in the terminal holding device 1, the direction of the terminal device 2 (specifically the image capturing direction by the camera 29 in the terminal device 2) can be appropriately detected.

FIG. 8C illustrates only the acceleration sensor 15d in FIG. 8B. The acceleration sensor 15d detects acceleration in two-dimensional directions, i.e., the X-direction and the Y-direction as shown in FIG. 8C. The X-direction corresponds to the image capturing direction of the camera 29. When the image capturing direction of the camera 29 deviates from the traveling direction of the vehicle 3, the deviation angle θ of the image capturing direction (X-direction) with respect to the traveling direction of the vehicle 3 can be calculated from the ratio of the X-direction acceleration to the Y-direction acceleration detected by the acceleration sensor 15d. The deviation angle δ can be calculated by the following equation (1):

Deviation Angle δ=arctan(Y-direction acceleration/X-direction acceleration) (1)

Specifically, the deviation angle δ is calculated by the CPU 21 in the terminal device 2. In this case, the CPU 21 obtains the output signals corresponding to the X-direction acceleration and the Y-direction acceleration detected by the acceleration sensor 15d, and calculates the deviation angle δ based on the output signals.

Then, when the deviation angle δ is smaller than a predetermined value, the CPU 21 determines that the difference between the image capturing direction and the traveling direction is within the predetermined range. When the deviation angle δ is equal to or larger than the predetermined value, the CPU 21 determines that the difference between the image capturing direction and the traveling direction is beyond the predetermined range.

It is not limited to determine the difference between the image capturing direction and the traveling direction only based on the output of the sensor such as the acceleration sensor 15d. The CPU 21 may determine the difference between the image capturing direction and the traveling direction, based on not only the output of the sensor but also the result of the image analysis of the captured image as shown in the embodiment and the first and second modified examples. Namely, by combining the output of the sensor and the result of the image analysis of the captured image which is obtained by not less than one of the embodiment and the first and second modified examples, the CPU 21 may determine the difference between the image capturing direction and the traveling direction. Therefore, in such a state that there is an obstacle in front of the camera 29 though the image capturing direction substantially coincides with the traveling direction, it becomes possible to prevent mistakenly switching the actually captured guide image to the map guide image.

### Fourth Modified Example

In a fourth modified example, the CPU 21 regularly determines the difference between the image capturing direction and the traveling direction during the AR navigation, so as to perform the display controlling for switching between the actually captured guide image and the map guide image. Namely, the CPU 21 repeatedly determines the difference in a predetermined cycle. Therefore, when the difference between the image capturing direction and the traveling direction occurs, it is possible to immediately switch the actually captured guide image to the map guide image.

### Fifth Modified Example

The above embodiment is applied to the terminal device 2 in a state held by the terminal holding device 1 (i.e., the terminal device 2 in a state mounted on the movable body by the terminal holding device 1). Meanwhile, a fifth modified example is applied to the terminal device 2 which is simply carried by the user. For example, the fifth modified example is applied to a case in which a pedestrian utilizes the route guide by using the terminal device 2.

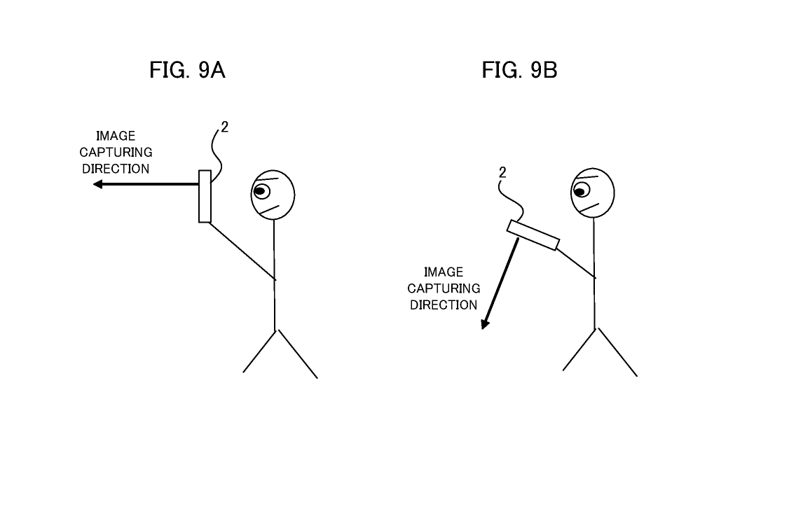

A concrete description will be given of the fifth modified example, with reference to FIGS. 9A and 9B. As shown in FIG. 9A, since it is preferable that the image capturing direction of the camera 29 is substantially horizontal when the user uses the AR navigation by the actually captured guide image during walking, the user tends to arrange the terminal device 2 vertically. Namely, the user tends to use the terminal device 2 in the state that the tilt of the terminal device 2 is substantially vertical with respect to a ground surface. Meanwhile, as shown in FIG. 9B, when the user uses the normal navigation by the map guide image during walking, the user tends to tilt the terminal device 2 in order to easily see the map guide image (as another reason, the user is tired if the terminal device 2 is arranged vertically as shown in FIG. 9A.). Namely, the user tends to use the terminal device 2 in the state that the tilt of the terminal device 2 is nearly-horizontal with respect to the ground surface.

Thus, in the fifth modified example, based on a relationship between the image capturing direction of the camera 29 and the tilt of the terminal device 2, the CPU 21 in terminal device 2 determines whether to preferentially display the actually captured guide image or the map guide image, i.e., the CPU 21 determines whether to preferentially perform the AR navigation or the normal navigation. Specifically, when a tilt of the image capturing direction of the camera 29 with respect to a horizontal plane is within a predetermined range, the CPU 21 determines to preferentially display the actually captured guide image. When the tilt of the image capturing direction of the camera 29 with respect to the horizontal plane is beyond the predetermined range, the CPU 21 determines to preferentially display the map guide image.

The “predetermined range” used in the above determination is preliminarily set in consideration of the tilt of the terminal device 2 when an actual pedestrian uses the AR navigation and the normal navigation. Additionally, the CPU 21 calculates the tilt of the image capturing direction of the camera 29 based on the output of the sensor 15d (gyro sensor) which detects the angular velocity about the horizontal axis of the movable body and/or the acceleration.

### Sixth Modified Example

While the present invention is applied to a vehicle in the above description, the application of the present invention is not limited to this. The present invention may be applied to various movable bodies such as a ship, a helicopter and an airplane other than the vehicle.

As described above, the embodiment is not limited to the embodiment described above, and may be alterable as needed without contradicting the gist and the idea of the invention readable from claims and specification in its entirety.

### INDUSTRIAL APPLICABILITY

The present invention can be used in a cell phone having a telephone call function and a navigation apparatus performing a route guide.

### DESCRIPTION OF REFERENCE NUMBERS

1 Terminal Holding Device
2 Terminal Device
3 Vehicle
15 Substrate Holder
16 Terminal Holder
21 CPU
25 Display Unit
28 Operation Unit
29 Camera

1-11. (canceled)

12. A terminal device, comprising:
an image capturing unit; and
a display controlling unit which displays either an actually captured image using a captured image captured by the image capturing unit or a map image, on a display unit,
wherein, based on an image capturing direction of the image capturing unit, the display controlling unit displays either the actually captured image or the map image on the display unit.

13. The terminal device according to claim 12, further comprising a detecting unit which detects a tilt of the terminal device,
wherein, based on the tilt of the terminal device detected by the detecting unit, the display controlling unit displays either the actually captured image or the map image, on the display unit.

14. The terminal device according to claim 13,
wherein the detecting unit detects a tilt of the image capturing direction, as the tilt of the terminal device,
wherein, when the tilt of the image capturing direction with respect to a horizontal plane is within a preliminarily set range, the display controlling unit displays the actually captured image on the display unit, and
wherein, when the tilt of the image capturing direction with respect to the horizontal plane is beyond the preliminarily set range, the display controlling unit displays the map image on the display unit.

15. The terminal device according to claim 12,
wherein the terminal device is held by a terminal holding device mounted on a movable body so that the image capturing direction coincides with a traveling direction of the movable body, and
wherein, when a holding by the terminal holding device is removed, the display controlling unit displays the map image on the display unit.

16. The terminal device according to claim 12,
wherein the display controlling unit detects a traveling direction of the terminal device by a sensor provided in the terminal device and/or a holding device which holds the terminal device, and displays either the actually captured image or the map image on the display unit, based on a difference between the image capturing direction and the traveling direction.

17. The terminal device according to claim 12,
wherein, based on the image capturing direction which is analyzed by an image of a road in the captured image, the display controlling unit displays either the actually captured image or the map image on the display unit.

18. The terminal device according to claim 12, further comprising a setting unit which sets a display of the actually captured image to invalid,
wherein, when the display of the actually captured image is set to invalid, the display controlling unit does not display the actually captured image even when a display of the actually captured image is prioritized.

19. An image displaying method executed by a terminal device which includes an image capturing unit, comprising:
a display controlling process which displays either an actually captured image using a captured image captured by the image capturing unit or a map image, on a display unit,
wherein, based on an image capturing direction of the image capturing unit, the display controlling process displays either the actually captured image or the map image on the display unit.

20. An image displaying computer program product stored in a non-transient tangible computer-readable medium and executed by a terminal device which includes an image capturing unit and a computer, the computer program product makes the computer function as:
a display controlling unit which displays either an actually captured image using a captured image captured by the image capturing unit or a map image, on a display unit,
wherein, based on an image capturing direction of the image capturing unit, the display controlling unit displays either the actually captured image or the map image on the display unit.
